(19) United States
(12) Patent Application Publication
(10) Pub. No.: US 2021/0389468 A1
(43) Pub. Date: Dec. 16, 2021

(54) ABSTANDSMESSEINHEIT

(71) Applicant: OSRAM GmbH, Munich (DE)

(72) Inventors: Christian Gammer, Traitsching (DE); David Jaskolka, Neutraubling (DE)

(73) Assignee: OSRAM GmbH, Munich (DE)

(21) Appl. No.: 17/284,831

(22) PCT Filed: Oct. 26, 2019
(86) PCT No.: PCT/EP2019/078472

§ 371 Date: Apr. 13, 2021

(30) Foreign Application Priority Data
Oct. 24, 2018 (DE) 10 2018 218 166.7

(51) Int. Cl. G01S 17/931; G01S 7/481; G01S 7/4865; G01S 7/484

(52) U.S. Cl. CPC G01S 17/931; G01S 7/4815; G01S 7/4817; G01S 7/484; G01S 7/4813; G01S 7/4865

(57) ABSTRACT

Systems and methods disclosed herein include distance-measuring unit for measuring a detection field based on a time-of-flight signal. The distance-measuring unit includes an emitter unit for emitting laser pulses, an optical unit for guiding the laser pulses into different solid angle segments, a sensor unit for receiving echo pulses from the solid angle segments, and a logic assembly configured to read the sensor unit, wherein at least the emitter unit, the optical unit, and the sensor unit are arranged on a common substrate.

### TECHNICAL FIELD

The present invention relates to a distance-measuring unit for measuring a detection field based on a time-of-flight signal.

### Prior Art

The distance measurement at issue is based on a time-of-flight measurement of emitted electromagnetic pulses. If the latter impinges on an object, then the pulse is proportionally reflected at the surface of said object back to the distance-measuring unit and can be recorded as an echo pulse by a suitable sensor. If the pulse is emitted at a point in time t₀ and the echo pulse is detected at a later point in time t₁, the distance d to the reflective surface of the object can be determined by way of the time of flight Δt_{A}=t₁−t₀ according to

d=Δt_{A}c/2 equ. 1.

Since electromagnetic pulses are involved, c is the value of the speed of light.

### SUMMARY OF THE INVENTION

The present invention addresses the technical problem of specifying a particularly advantageous distance-measuring unit.

This is solved according to the invention by the distance-measuring unit as claimed in claim 1. In this case, one special feature resides in the fact that at least the emitter unit for emitting the laser pulses, an optical unit for distributing the laser pulses and a sensor unit for receiving the echo pulses are arranged on a common substrate. Preferably, a logic assembly for reading the sensor unit is also arranged on said substrate, see below in detail.

Combining the components can yield a compact construction, for example, in other words it can be advantageous with regard to the structural space. Especially with regard to a preferred motor vehicle application, this can open up new possibilities for integration; the distance-measuring unit can be integrated into a headlight, for example. The reduced structural space can also be accompanied by a weight reduction, which e.g. can also open up entirely new areas of application, for instance use in drones or movable luminaires or headlights/spotlights. One example is so-called moving heads, in which a spotlight head is mounted rotatably and pivotably on a spotlight base, wherein a reduction of weight can reduce a loading on the suspension and thus enable this integration.

The components arranged “on” the common substrate need not necessarily all be mounted directly on the substrate, or in other words they can be connected by joining (soldered or adhesively bonded) directly to the substrate. Specifically, the components can also be placed one on top of another, in other words stacked. The arrangement of a component “on” the substrate means in this respect that a projection of the component perpendicular to the substrate surface lies in the latter. If e.g. one component is placed directly onto the substrate and a further component is then placed onto the component mentioned first, the projections of both components lie in the substrate surface (and e.g. the projection of the placed component lies completely within that of the component underneath).

The “common substrate” can generally e.g. also be a printed circuit board, for instance an FR4 printed circuit board. However, a semiconductor-based substrate is likewise possible as well, for instance a silicon substrate, or else a metallic substrate, in the simplest case a metal plate, e.g. a stamped sheet of metal.

Preferred configurations can be found in the dependent claims and the entire disclosure, wherein a distinction is not always drawn specifically between device and method and/or use aspects in the presentation of the features; the disclosure should be read implicitly at any rate with regard to all claim categories. That is to say that if e.g. a distance-measuring unit suitable for specific operation is described, that should be seen at the same time to include a disclosure of a corresponding operating method, and vice versa.

By means of the emitter and optical units, the laser pulses can be guided into different solid angle segments of the detection field. The detection field can thus be scanned solid-angle-selectively, which yields a point line or cloud of distance values and thus a one- or two-dimensional distance image. As discussed in detail below, the solid-angle-selective emission can preferably be realized by way of a micromirror actuator (MEMS mirror) as optical unit, which, in different oscillation and thus tilting positions, reflects laser pulses incident from a laser diode into the different solid angle segments.

Alternatively, the solid angle selectivity can e.g. also be realized with an array of laser diodes to which a lens or a lens system is assigned as optical unit. Via the lens/lens system, each laser diode is then assigned a dedicated solid angle segment into which the laser pulses emitted by the respective laser diode are refracted. For this purpose, a dedicated lens can be provided for each laser diode, wherein these lenses can be offset or tilted to different extents. However, the deflection into the different solid angle segments can e.g. also be achieved with one lens jointly assigned to the laser diodes.

Independently of the configuration of emitter and optical units in specific detail, one advantage of the present subject matter can e.g. also reside in the fact that by arranging the components crucial for guiding the laser and echo pulses on the same substrate, their alignment relative to one another can also be simplified. In the ideal case, time-consuming optical calibration processes can at least be reduced. Against this background, too, in a preferred configuration, mounting stops for the emitter unit, the optical unit and/or the sensor unit are provided on the common substrate. If components that are rectangular in a plan view, for example, are assumed, the mounting stops e.g. per component can be arranged at least at two mutually opposite corners (or else at all four corners). However, the mounting stops can e.g. also be provided at the side edges of the respective component, in other words between the corners thereof. Depending on the configuration of the substrate in specific detail, the mounting stops can be e.g. uncovered by etching or else applied, for instance deposited as oxide, nitride or metallization webs.

In general, e.g. a so-called surface emitter (Vertical Cavity Surface Emitting Laser, VCSEL) could also be provided as emitter unit or laser diode. An edge emitter is preferred, in other words that the laser radiation is emitted at a side edge of the laser diode chip out of the layer construction thereof. The emission surface is also referred to as a laser facet. In this case, in particular, chips or layer constructions having a plurality of laser facets are also possible, also referred to as Stacked Device. In general, the laser diode can also be the semiconductor chip on its own (Bare Die), but the laser diode is preferably a packaged assembly.

The laser radiation is preferably infrared radiation, in other words wavelengths of e.g. at least 600 nm, 650 nm, 700 nm, 750 nm, 800 nm or 850 nm (with increasing preference in the order designated). Around 905 nm, for example, may be particularly preferred, wherein in this respect advantageous upper limits may be at at most 1100 nm, 1050 nm, 1000 nm or 950 nm (with increasing preference in the order designated). A further preferred value may be e.g. around 1064 nm, which yields advantageous lower limits of at least 850 nm, 900 nm, 950 nm or 1000 nm and advantageous upper limits (independent thereof) of at most 1600 nm, 1500 nm, 1400 nm, 1300 nm, 1200 nm or 1150 nm (in each case with increasing preference in the order designated). Preferred values may also be around 1548 nm or 1550 nm, which yields advantageous lower limits of at least 1350 nm, 1400 nm, 1450 nm or 1500 nm and advantageous upper limits (independent thereof) of at most 2000 nm, 1900 nm, 1800 nm, 1700 nm, 1650 nm or 1600 nm (in each case with increasing preference in the order designated). In general, however, e.g. wavelengths in the far IR also are conceivable, e.g. at 5600 nm or 8100 nm.

In a preferred configuration, the logic assembly is also arranged on the common substrate. In general, the logic assembly can e.g. also be a programmable microcontroller; an ASIC (Application Specific Integrated Circuit) is preferred. In particular, a so-called application specific standard product (ASSP) can be used. A mixed signal ASIC, which integrates digital and analog functions, can preferably be used.

The logic assembly is configured at least for reading the photodiode; it preferably additionally controls the emitter and/or optical unit, preferably the combination of laser diode and MEMS mirror. The sensor unit can comprise exactly one or else a plurality of photodiodes, this last enabling solid-angle-sensitive detection, in other words the assignment of echo pulses to different solid angle segments. As photodiode, e.g. a PIN diode, APD (Avalanche Photo Diode) or SPAD (Single Photon APD), or else a photomultiplier is possible. If a plurality of photodiodes are present, they are preferably all read or evaluated by the logic assembly.

Generally, “reading the sensor unit” can comprise converting an analog input signal into a digital signal. The input signal is preferably tapped off directly at the sensor unit, in other words without a further assembly inbetween. In other words, the logic assembly performs the function of an A/D converter. Preferably, the digitized signal is conditioned further for a subsequent image evaluation, in other words is averaged e.g. over a plurality of echo pulses (of the same solid angle segment, captured at different points in time). A conditioned digital signal is thus output to a downstream computer unit, which establishes e.g. a point cloud of distance values from the measurement values.

In accordance with one preferred embodiment, both the logic assembly and the sensor unit are arranged on the common substrate, but the latter is provided with a cutout between these components. Proceeding from a side edge of the substrate, for example, a slot can extend between the logic assembly and the sensor unit. The cutout is preferably a through hole, which is thus enclosed by the substrate toward all sides in the area directions of the substrate. This can be advantageous e.g. with regard to stability (torsional stiffness). Perpendicular to the area directions, the cutout preferably extends through the entire substrate, in other words through all substrate layers for instance in the case of a multilayered construction.

The cutout between logic assembly and sensor unit can be advantageous with regard to thermal decoupling. Specifically, firstly a comparatively great power loss can be incurred in the logic assembly, such that the latter becomes relatively hot during operation. Secondly, the photocurrent of the photodiode or photodiodes can exhibit a relatively great temperature dependence, for which reason the temporally and also spatially fluctuating heating as a result of the logic assembly could adversely affect the quality of the measurement, in particular worsen the signal/noise ratio. The heating of the sensor unit can e.g. also negatively influence the inherent noise of the photodiode or photodiodes.

In accordance with one preferred embodiment, the emitter unit and the optical unit are arranged on the logic assembly. In other words, in particular a laser diode and a MEMS mirror can be positioned on the logic assembly. The underside of the logic assembly faces the substrate; the emitter and optical units are placed onto the opposite top side; for this purpose, corresponding mounting stops can be provided on the top side of the logic assembly, which simplifies alignment (see above).

In a preferred configuration, a driver unit, by which the emitter unit or laser diode can be operated in a pulsed manner, is also arranged on the common substrate. Said driver unit comprises an energy store, which makes the charge available, and furthermore a transistor, which then switches said charge to the laser diode. Arranging these components on the common substrate can e.g. also be advantageous with regard to short connection paths in the discharge circuit. As a result, it is possible at least to reduce inductances, which can shorten the switching times and thus increase the edge steepness of the pulses. This last can be advantageous e.g. with regard to increasing the range of the distance-measuring unit.

Specifically, if it is assumed e.g. that the pulse energy accommodated overall per pulse is limited for reasons of eye safety, in order to increase the range with the pulse duration unchanged it is not possible simply to increase the output power because this would produce critical pulse energies. However, if the pulse duration is shortened, e.g. from 10 ns to 2 ns, the output power can be increased by up to five-fold with the pulse energy remaining the same (given a repetition rate of e.g. around 100 kHz). Moreover, increasing the output power may be of interest not just with regard to the range, but rather may generally improve the signal/noise ratio and thus reduce e.g. the detection outlay at the receiver end (use of simpler and thus more cost-effective sensors, etc.).

In accordance with one preferred embodiment, at least one part of the driver unit, namely the transistor, is arranged on the logic assembly. In combination with the emitter and optical units arranged on the logic assembly, it is then possible to achieve e.g. a particularly short and thus low-resistance or low-inductance connection between transistor and laser diode. Preferably, not only the transistor, but also the energy store is arranged on the logic assembly. In the arrangement on the logic assembly, multiple stacking is also possible; e.g. the energy store and the laser diode can be placed directly onto the logic assembly and the transistor e.g. as a flip-chip assembly can be placed onto the laser diode and the energy store.

The energy store is very generally preferably a capacitor that is linked to and charged from the supply voltage (and is discharged by the laser diode as a result of the switching of the transistor). Even if in general e.g. an electrolytic or plastic or film capacitor can also be considered, in a preferred configuration a silicon-based capacitor is provided. In this case, the capacitor plates can be formed by electrically conductive silicon, preferably polysilicon. A dielectric layer, i.e. a nitride or oxide, is arranged between two layers of polysilicon. In this case, the electrodes need not necessarily be embodied in planar fashion; they can also follow a topography, in other words be compressed (folded) in the area direction of the substrate. A large electrode area or capacitance can thus be realized overall in an area-saving manner.

In comparison with a ceramic capacitor, for instance, which could generally also be used, a silicon-based capacitor can have e.g. a ten-fold higher capacitance density, at the same time the equivalent series inductance (ESL) being very low and the natural frequency being high (greater than 1 GHz to 10 GHz). In addition, a silicon-based capacitor in the present context can also be advantageous on account of the comparatively small construction height. It can have a height comparable to that of the laser diode or other assemblies, which makes possible the stacking outlined above without complex height adaptation (on a planar substrate).

In a preferred configuration, the silicon substrate of the polysilicon capacitor is simultaneously used as carrier; specifically, it forms the common substrate. In other words, at least the emitter and optical units, and the sensor unit are then arranged on this substrate in or on which the polysilicon capacitor is structured. Preferably, in this case, both terminals of the capacitor are arranged on the same side of the silicon substrate, namely on the top side. In addition to the laser diode, with further preference the transistor is then also positioned thereon. Moreover, conductor tracks etc. can also be deposited or structured on the surface of the silicon substrate of the capacitor in order to create a wiring of the individual assemblies.

It is then possible in particular to mount the laser diode with its P-type contact facing the substrate on a conductor track deposited thereon. The transistor as flip-flop is then furthermore connected connected to said conductor track (the terminals of the transistor face downward, in the direction of the silicon substrate of the capacitor). The drain terminal of the transistor passes directly to a terminal pad of the silicon-based capacitor, in other words ultimately also a conductor track (which is in contact with the underlying polysilicon layer). If the laser diode is a vertical component, which is preferred, then the N-type contact lies at the top side, in other words facing away from the silicon substrate. Even though in general direct tapping off is also possible, e.g. using a clip, the top side contact of the laser diode can preferably be connected to a conductor track on the silicon substrate via one or more bond wires, said conductor track forming the ground terminal. Said conductor track is then also connected to the ground contact of the silicon-based capacitor.

In accordance with one preferred embodiment, at least the emitter and optical units, and the sensor unit and preferably also the logic assembly, are arranged in a common housing. The latter can delimit a gas volume around the components, in other words be filled e.g. with air or else an inert gas. Insofar as the common substrate encloses the components toward the bottom, the housing can encompass them toward the side and toward the top. Housing the components in common fashion can e.g. in turn be advantageous with regard to a compact construction. Preferably, the emitter unit and the sensor unit are indeed arranged in the common housing, but are separated from one another by way of a partition wall in the housing.

In a preferred configuration, the housing comprises a lens of the optical unit and a lens assigned to the sensor unit. In other words, therefore, optical elements for guiding the pulses and also the echo pulses via the housing or as part of the housing are positioned relative to one another, which can be advantageous with regard to accuracy and also alignment effort. In general, the lenses can e.g. also be molded integrally into the housing; the latter could therefore e.g. be injection-molded form a transparent plastic material and be provided in lens-shaped fashion here at the corresponding locations.

In a preferred configuration, however, the lenses as separate components are each placed against an opening of a housing element. The housing element can then e.g. also be provided such that it is light-nontransmissive, which can prevent e.g. entry of stray radiation. By way of the housing element, the lenses can advantageously be positioned relative to one another; the housing element can preferably have mounting stops for the lenses. The non-integral configuration of the lenses with the housing element can e.g. also provide freedoms in material selection and/or optimization.

As already mentioned, in a preferred configuration, the emitter unit is a laser diode and the pulses thereof are distributed among the different solid angle segments by means of a micromirror actuator, in particular a MEMS mirror. The lens just discussed can then be a lenticular lens, in particular, which fans out each pulse, specifically in a manner angled in one direction or perpendicular to the scanning direction (which results from the movement of the MEMS mirror). In other words, therefore, each pulse is fanned out in a plane which is perpendicular to the mirror surface.

At the emitter end, the resolution results from the fact that a respective pulse reaches a specific solid angle segment in a respective mirror position. “Eavesdropping” then takes place for a specific pause duration to establish whether an echo pulse returns from this solid angle segment before emission into another solid angle segment and eavesdropping once again is effected in another mirror position. If the pulses are additionally fanned out, as just outlined, within a respective emitter solid angle segment, the more extensive assignment can be realized at the receiver end.

For this purpose, a plurality of individually readable sensor areas are provided, for example, which can be arranged next to one another in a series, for example. In principle, integration in the form of a CCD or CMOS array is also conceivable; preferably, a respective sensor area is formed in each case by a separate photodiode, that is to say that a plurality of photodiodes are positioned next to one another, preferably as a linear array. A spatial resolution is thus provided, which, in combination with an optical element disposed upstream from the viewpoint of the echo pulses, produces a solid angle resolution. Said optical element can be realized as a converging lens, for example, which guides echo pulses originating from different receiver solid angle segments onto the different sensor areas or photodiodes.

The solid-angle-selective emitter unit is preferably combined with such a solid-angle-sensitive receiver unit. Preferably, an arrangement is such that the detection field is subdivided in one direction into the emitter solid angle segments and in an angled manner or perpendicular thereto into the receiver solid angle segments. In particular, this results in a resolution on two axes, that is to say a two-dimensional distance image. As just outlined, in this case a respective pulse can be fanned out into a multiplicity of pulses within a respective emitter solid angle segment by a lens (in particular lenticular lens). The assignment as to whether or with respect to which of these pulses echo pulses return then arises with the solid-angle-sensitive sensor unit. In other words, therefore, each of the emitter solid angle segments is subdivided into a plurality of receiver solid angle segments.

In one preferred embodiment, the distance-measuring unit comprises a plurality of emitter and optical units, preferably a plurality of laser diodes with an assigned MEMS mirror in each case. The emitter and optical units are arranged in such a way that the solid angle segments of the optical units among one another are situated at least partly disjointly with respect to one another. In other words, therefore, the same angle range is not measured by a plurality of emitter and/or optical units, rather a detection field that is larger overall is spanned. Particularly preferably, an arrangement can be such that there is no overlap between the emitter solid angle segments of the different optical units (MEMS mirrors), but these adjoin one another. Preferably, the plurality of emitter and receiver units provided are all arranged on the common substrate, in other words the latter also provides a relative positioning of the units among one another.

In a preferred configuration, a plurality of micromirror actuators are provided (as optical units). They each span an angle range and are preferably arranged such that a total angle range spanned overall is greater than each individual angle range. Relative to the installation position of the distance-measuring unit, it may be preferred, in particular, for the angle ranges to be placed horizontally against one another, preferably in a manner free of overlap.

At least two MEMS mirrors can be placed against one another with their angle ranges; possible upper limits can be (independently thereof) e.g. at most 7, 6, 5 or 4 MEMS mirrors. Particularly preferably, there may be three MEMS mirrors. Generally, a respective MEMS mirror can have mechanically a deflectability of, in terms of absolute value (+/−), at least 10° or 12° and (independently thereof) e.g. not more than 20° or 18°. Particular preference may be given to +/−15° (mechanically), which results in an optical deflection of +/−30°. The total angle range preferably has an aperture angle of at least 40°, more preferably and particularly preferably at least 45° or 50°, respectively. Possible upper limits can be (independently thereof) e.g. at most 140°, 130° or 120°.

As mentioned, placing the optical units or angle ranges horizontally against one another is preferred, but additionally or else alternatively a vertical construction is also possible. Preferably, however, the resolution is realized in a vertical direction at the receiver end, in other words by way of the solid-angle-sensitive sensor unit, see above.

Placing a plurality of MEMS mirrors against one another can firstly be advantageous with regard to the increased total angle range. In a preferred configuration, a respective dedicated sensor unit is also assigned to each emitter unit and optical unit, which can then also be advantageous with regard to the temporal resolution or to reduce the evaluation complexity. Specifically, each angle range can then be scanned by itself as a dedicated unit, in other words that the angle ranges can also be detected time-synchronously among one another. If three angle ranges are assumed, for example, the total angle range can be scanned in one third of the measurement time, which can be converted e.g. into a higher temporal resolution or an improved signal/noise ratio (averaging of a larger number of measurements).

If the angle ranges are preferably free of overlap (see above), there may be no need at all for more extensive synchronization, that is to say that the angle ranges can each be measured by themselves at the same time. In this case, the MEMS mirrors can also oscillate with different frequencies, in principle, even if the same frequency is preferred. Preferably, the MEMS mirrors are coordinated with one another or clocked in such a way that those solid angle segments which adjoin one another, but at the same time are assigned to different angle ranges (MEMS mirrors), are always scanned in a temporally offset manner. By not carrying out measurements simultaneously at these interfaces, possible crosstalk and thus undesired interference can be prevented. Scanning with the same frequency in conjunction with a maximum offset between the solid angle segments may be preferred in this respect.

The invention also relates to the use of a distance-measuring unit disclosed in the present invention in a motor vehicle, e.g. a truck or motorcycle, preferably in an automobile. Application in a partly or fully autonomous driving vehicle is particularly preferred. In general, an application in an aircraft or watercraft is also conceivable, for instance an airplane, a drone, a helicopter, train or ship. Further fields of applications may be in the field of indoor positioning, that is to say identifying the location of persons and objects within buildings; detection of a plant structure (morphological identification during plant cultivation) is also possible, e.g. during a growth or ripening phase; there may also be applications in the field of control (tracking) of an effect luminaire in the entertainment field; control (tracking) of a robot arm in the industrial and medical fields is likewise possible.

### BRIEF DESCRIPTION OF THE DRAWINGS

The invention is explained in greater detail below on the basis of an exemplary embodiment, wherein the individual features within the scope of the alternative independent claims may also be essential to the invention in a different combination and a distinction is still not drawn specifically between the different claim categories.

In the figures specifically

FIG. 1 shows a distance-measuring unit according to the invention in a schematic sectional view;

FIG. 2 shows a plan view illustration with respect to the distance-measuring unit in accordance with FIG. 1;

FIG. 3 shows a further distance-measuring unit according to the invention in a schematic plan view;

FIG. 4 shows a further distance-measuring unit according to the invention in a schematic plan view, wherein the solid angle selectivity is achieved differently than in the variant in accordance with FIG. 3;

FIG. 5 shows a schematic sectional view with a detail view with respect to FIG. 4;

FIG. 6 shows a further distance-measuring unit according to the invention in a schematic sectional view;

FIG. 7 shows a schematic illustration of the subdivision of a detection field that is realized in combination at the emitter and receiver ends;

FIG. 8 shows schematically and in plan view how angle ranges of individual MEMS mirrors are combined to form a total angle range.

### PREFERRED EMBODIMENT OF THE INVENTION

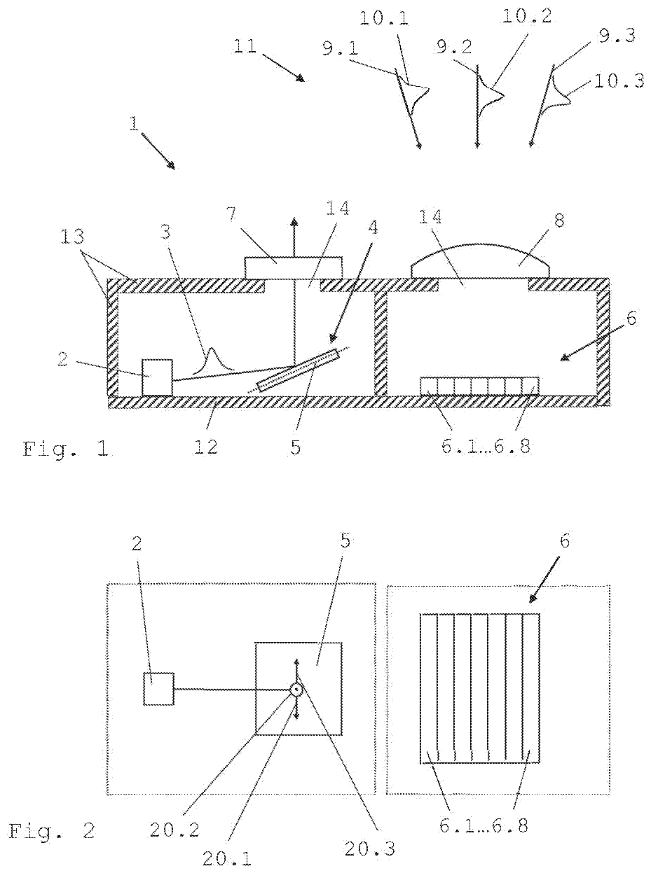

FIG. 1 shows a distance-measuring unit 1 according to the invention in sectional view. This distance-measuring unit comprises an emitter unit 2, namely a laser diode, which emits laser pulses 3 during operation. Via an optical unit 4, in the present case a micromirror actuator 5 (MEMS mirror), the laser pulses 3 are successively reflected into different solid angle segments, cf. FIG. 2 for illustration.

The distance-measuring unit 1 furthermore comprises a sensor unit 6 having a plurality of photodiodes 6.1-6.8 arranged next to one another, cf. FIG. 2. If a respective laser pulse 3 is reflected into a respective solid angle segment 20.1-20.3 via the micromirror actuator 5, echo pulses can return from different regions of the respective emitter solid angle segment 20.1-20.3. Specifically, during emergence from the distance-measuring unit 1, the respective laser pulse 3 is fanned out by a lens 7, a lenticular lens (in the plane of the drawing in the illustration in accordance with FIG. 1).

A lens 8 is assigned to the sensor unit 6, said lens guiding echo pulses 10.1-10.3 that are incident from different directions 9.1-9.3 onto different photodiodes 6.1-6.8. A respective echo pulse 10.1-10.3 returns from a respective direction 9.1-9.3 if an object at which a respective laser pulse 3 is reflected is situated there. The lens 8 then converts the solid angle distribution of the echo pulses 10.1-10.3 into a spatial distribution. In the overall consideration, with firstly the solid-angle-selective emission and secondly the solid-angle-sensitive reception perpendicular thereto, a detection field 11 can be scanned two-dimensionally.

The emitter unit 2, the micromirror actuator 5 and the sensor unit 6 are mounted on a common substrate 12. The optical coupling outlined in the paragraphs above requires an exact positioning of these components 2, 4, 6 relative to one another, which can be achieved with the arrangement on the common substrate 12.

The components 2, 4, 6 are also housed in common fashion, in other words are enclosed by a housing element 13 laterally and also in a direction opposite to the substrate 12. The components 2, 4, 6 are mounted on the substrate 12, and the housing element 13 is attached thereto. At its top side said housing element has two through openings 14, against which the lenticular lens 7 and the lens 8 of the sensor unit 6 are placed. Respective mounting stops are provided both for the components 2, 4, 6 and for the lenses 7, 8, this not being illustrated in specific detail in the present case.

The tilting or oscillation axis of the micromirror actuator 5 is situated obliquely in the plane of the drawing in FIG. 1; in the plan view in accordance with FIG. 2, during an oscillation period the micromirror actuator 5 tilts with its upper half firstly toward the observer (and correspondingly with the lower half away from the observer) and then away from the observer (and correspondingly with the lower half toward the observer). The emission into the individual solid angle segments 20.1-20.3 is effected sequentially; in this case, eavesdropping takes place for a specific pause duration, dependent on the range, to ascertain whether an echo pulse or echo pulses 10.1-10.3 return(s) from the respective solid angle segment. Within a respective emitter-end solid angle segment 20.1-20.3, the echo pulses 10.1-10.3 are then assigned solid-angle-sensitively by means of the sensor unit 6, see above.

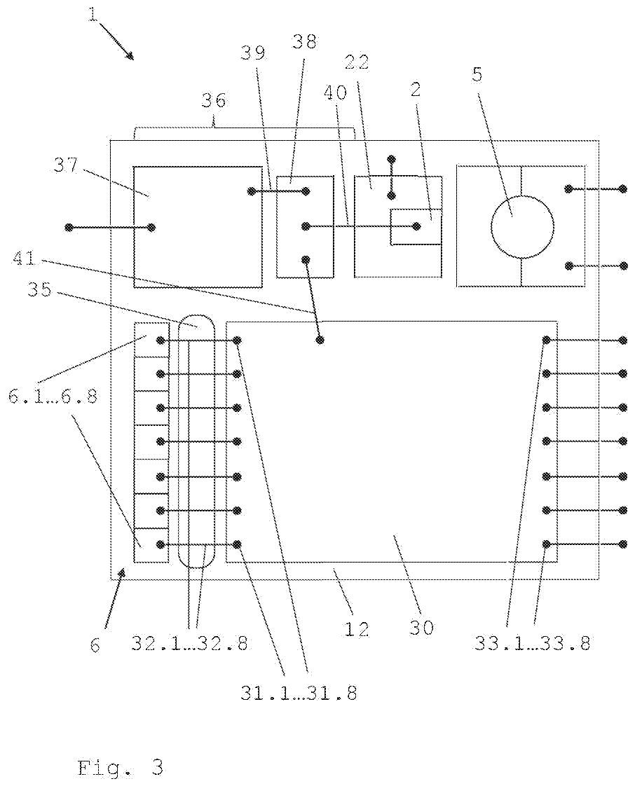

FIG. 3 shows a further distance-measuring unit 1 according to the invention in a plan view. Once again a laser diode 2 and a micromirror actuator 5 are arranged on a substrate 12. Generally, in the present case, parts having the same or a comparable function are provided with the same reference signs and, in this respect, reference is always also made to the description concerning the rest of the figures. The laser diode 2 is arranged on a heatsink 22; also cf. the sectional view in accordance with FIG. 6.

Furthermore, a sensor unit 6 constructed from eight photodiodes 6.1-6.8 is arranged on the substrate 12. Analogously to the description concerning FIGS. 1 and 2, via the micromirror actuator 5, in different tilting positions, laser pulses are reflected into different solid angle segments (fanned out per solid angle segment by a lenticular lens (not illustrated here)). The echo pulses returning after reflection at an object are detected by means of the sensor unit 6, specifically solid-angle-sensitively within a respective emitter-end solid angle segment (a lens (not illustrated) converts the solid angle distribution into a spatial distribution on the photodiodes 6.1-6.8).

Furthermore, a logic assembly 30, namely an ASIC, is arranged on the substrate 12. It has a plurality of inputs 31.1-31.8, which are connected to a respective photodiode 6.1-6.8 in each case via a bond wire 32.1-32.8. In the logic assembly 30, the analog input signals of the photodiodes 6.1-6.8 are preamplified and then converted into digital signals by internal A/D converters. Furthermore, signal conditioning to some extent is also already performed (e.g. averaging over a plurality of pulses); also cf. in specific detail the introductory part of the description. The digital signals are then passed on to an external computer unit (not illustrated) via outputs 33.1-33.8.

On account of a power loss, the logic assembly 30 heats up during operation. In order to thermally decouple the logic assembly 30 from the sensor unit 6 and the photodiodes 6.1-6.8 thereof, between these two components 6, 30 a cutout 35 is provided in the substrate 12, namely a through hole. Heat conduction via the substrate 12 between the logic assembly 30 and the sensor unit 6 is thus interrupted, which is advantageous with regard to the operation of the photodiodes 6.1-6.8 (e.g. reduction of inherent noise, also cf. in detail the introductory part of the description).

In the case of the distance-measuring unit 1 in accordance with FIG. 3, a driver unit 36 is furthermore arranged on the substrate 12, specifically a capacitor as energy store 37 and a transistor 38, by which the charge can be switched to the laser diode 2. In the present case, the transistor 38 is an eGaN FET transistor. The latter is connected to the energy store 37 via a drain connection 39; a source connection 40 passes to the laser diode (to the P-type contact thereof, its N-type contact being at ground potential). The logic assembly 30 drives the transistor 38 via a gate connection 41. All these components are arranged on the common substrate 12, which results in a compact construction overall. More extensive integration may also be preferred to the effect that the logic assembly 30 additionally drives the micromirror actuator 5, either directly or via interposed driver electronics, which are then preferably likewise arranged on the substrate 12 (these variants are not illustrated in specific detail).

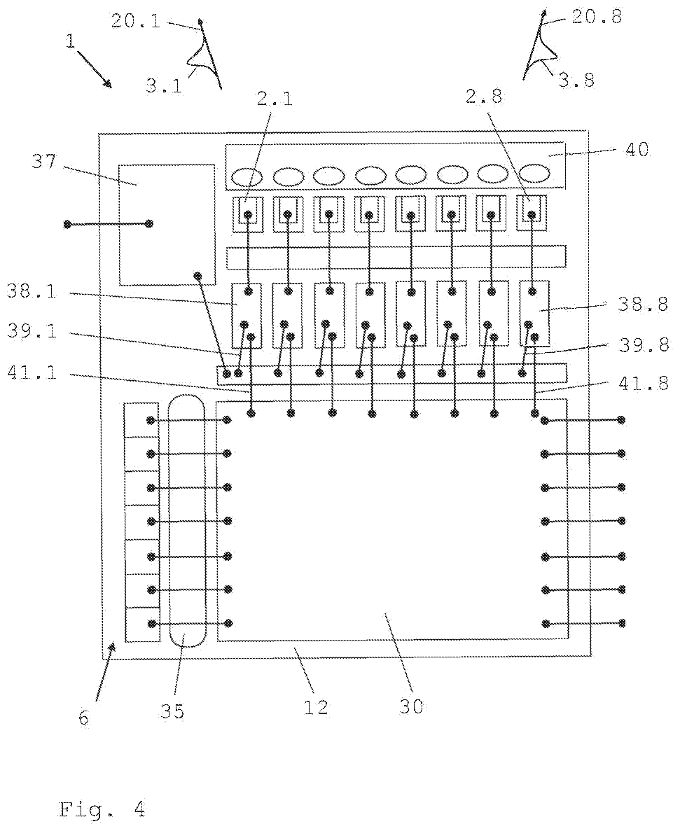

FIG. 4 shows a further distance-measuring unit 1, wherein a logic assembly 30 and a sensor unit 6 are arranged on a common substrate 12. In contrast to the variant in accordance with FIG. 3, in this case the solid-angle-selective emission is not realized by way of a tiltable mirror, but rather with a plurality of laser diodes 2.1-2.8. The respective pulse 3.1-3.8 thereof, is guided via an optical element 40 in each case into a dedicated solid angle segment 20.1-20.8 (and in this case fanned out per solid angle segment once again by a lenticular lens; cf. the description above). The laser diodes 2.1-2.8 emit sequentially (“eavesdropping” takes place for a specific pause duration per solid angle segment); within a respective emitter-end solid angle segment 20.1-20.8, the returning echo pulses are then detected solid-angle-sensitively by the sensor unit 6.

The laser diodes 2.1-2.8 are operated by means of a respective transistor 38.1-38.8 analogously to the description above. The drain connections 39.1-39.8 of said transistors are jointly linked to the energy store 37; the source connections 40.1-40.8 pass to the respective laser diode 2.1-2.8. For separate and in particular sequential driving, each gate terminal 41.1-41.8 is connected to the logic assembly 30 separately in each case.

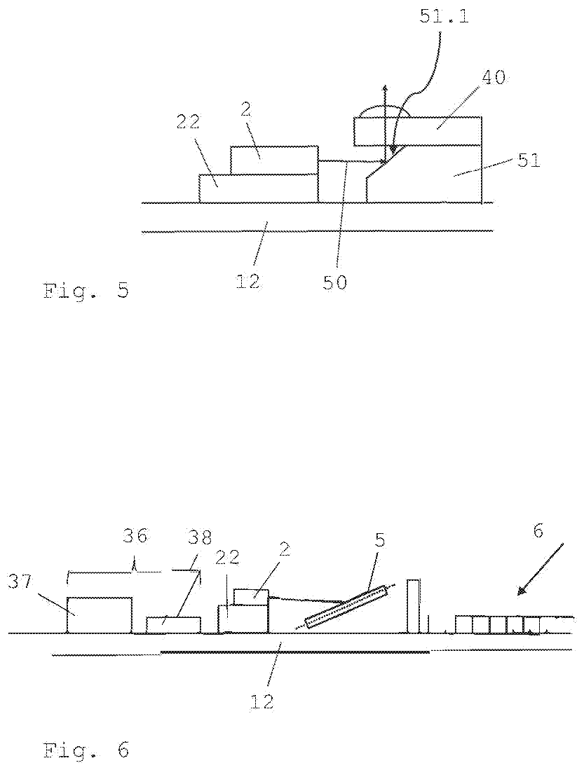

FIG. 5 illustrates, in a detail view of an arrangement in accordance with FIG. 4, how the laser radiation 50 is guided through the optical element 40. The optical element 40 is mounted on a mirror element 51; the laser radiation 50 is reflected upward at an oblique mirror surface 51.1, in other words out of the plane of the drawing in FIG. 4.

FIG. 6 shows a further distance-measuring unit 1 according to the invention in a schematic sectional view; in this case, the solid-angle-selective emission is again achieved by means of a micromirror actuator 5. Once again a driver unit 36 comprising energy store 37 and transistor 38 is also arranged on the common substrate 12. If the substrate 12 were viewed in a plan view, the configuration of micromirror actuator 5 and sensor unit 6 would be analogous to that in accordance with FIG. 2.

In an alternative variant, it is possible for the energy store 37 not to be placed onto the substrate 12, rather for said energy store for its part to form the substrate. In this case, the capacitor is structured with polysilicon electrodes and an oxide or nitride layer between the polysilicon. The capacitor or energy store then for its part serves as a carrier for the rest of the components 5, 6, 38.

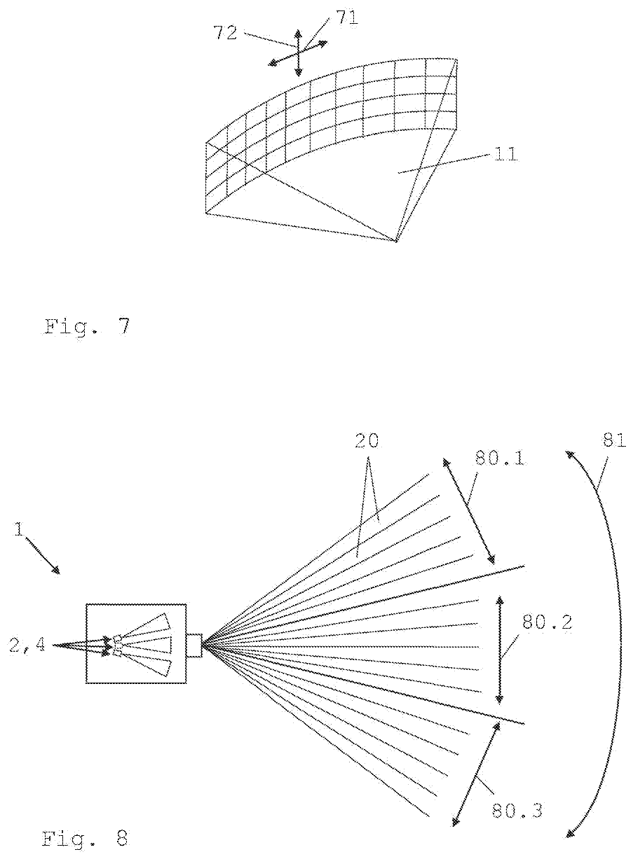

FIG. 7 illustrates how the detection field 11 is subdivided into a two-dimensional grid field by the combination of solid-angle-selective emission on a first axis 71 and solid-angle-sensitive reception on a second axis 72. A distance value is determined for each field, which produces a three-dimensional point cloud in the overall consideration.

FIG. 8 shows a further distance-measuring unit 1 constructed from three emitter and optical units 2, 4 placed next to one another, namely micromirror actuators, each of which spans an angle range 80.1-80.3. These angle ranges 80.1-80.3 adjoin one another; a resulting total angle range 81 has approximately triple the aperture angle (3×17°). During operation, the angle ranges 80.1-80.3 are scanned simultaneously, wherein the scanning of the individual solid angle segments 20 is clocked per angle range 80.1-80.3 such that there is always a maximum offset, in other words that two solid angle segments adjoining one another are never scanned at the same time.

### LIST OF REFERENCE SIGNS

Distance-measuring unit 1
Emitter unit 2
Laser diodes 2.1-2.8
Laser pulses 3.1-3.8
Optical unit 4
Micromirror actuator 5
Sensor unit 6
Photodiodes 6.1-6.8
Lens (optical unit) 7
Lens (sensor unit) 8
Directions 9.1-9.3
Echo pulses 10.1-10.3
Detection field 11
Substrate 12
Housing element 13
Through openings 14
Lens 18
Solid angle segments 20.1-20.8
Logic assembly 30
Inputs 31.1-31.8
Bond wire 32.1-32.8
Outputs 33.1-33.8
Cutout 35
Driver unit 36
Energy store 37
Transistor 38.1-38.8
Drain connections 39.1-39.8
Optical element 40
Source connections 40.1-40.8
Gate connections 41.1-41.8
Laser radiation 50
Mirror element 51
Mirror surface 51.1
First axis 71
Second axis 72
Angle ranges 80.1-80.3
Total angle range 81

1. A distance-measuring unit for measuring a detection field based on a time-of-flight signal, comprising the following components:
an emitter unit for emitting laser pulses;
an optical unit for guiding the laser pulses into different solid angle segments;
a sensor unit for receiving echo pulses from the solid angle segments; and
a logic assembly configured to read the sensor unit;
wherein at least the emitter unit, the optical unit, and the sensor unit are arranged on a common substrate.

2. The distance-measuring unit as claimed in claim 1, wherein a mounting stop is provided for at least one of emitter unit, the optical unit, and the sensor unit on the common substrate.

3. The distance-measuring unit as claimed in claim 1, wherein the logic assembly is also arranged on the common substrate.

4. The distance-measuring unit as claimed in claim 3, wherein the logic assembly and the sensor unit are arranged next to one another on the common substrate, and wherein the common substrate is provided with a cutout, preferably a through hole, between the logic assembly and the sensor unit.

5. The distance-measuring unit as claimed in claim 3, wherein the emitter unit and the optical unit are arranged on the logic assembly.

6. The distance-measuring unit as claimed in claim 1, wherein a driver unit for pulsed operation of the emitter unit is arranged on the common substrate, the driver unit comprising an energy store and a transistor connected in series with the emitter unit.

7. The distance-measuring unit as claimed in claim 6, wherein at least the transistor is arranged on the logic assembly.

8. The distance-measuring unit as claimed in claim 6, wherein the energy store comprises a polysilicon capacitor in a silicon substrate.

9. The distance-measuring unit as claimed in claim 8, wherein the silicon substrate of the polysilicon capacitor forms the common substrate on which at least the emitter unit, the optical unit, and the sensor unit are arranged.

10. The distance-measuring unit as claimed in claim 1, wherein at least the emitter unit, the optical unit, and the sensor unit are provided in a common housing, the housing comprising a first lens of the optical unit and a second lens assigned to the sensor unit.

11. The distance-measuring unit as claimed in claim 10, wherein the first and second lenses are separate components that are each placed against an opening of a housing element.

12. The distance-measuring unit as claimed in claim 1, wherein the emitter unit is a laser diode and the optical unit is a micromirror actuator, at which the laser pulses emitted by the laser diode are emitted into the different solid angle segments based on a position of the micromirror actuator.

13. The distance-measuring unit as claimed claim 1, further comprising a plurality of emitter units and a plurality of optical units, wherein the solid angle segments of each of the plurality of optical units are situated at least partly disjointly with respect to one another.

14. The distance-measuring unit as claimed in claim 12, further comprising a plurality of micromirror actuators, each spanning an angular range, wherein the plurality of micromirror actuators arranged in such a way that they collectively span a total angle range that is larger in comparison with a sum of the angular ranges of each of the plurality of micromirror actuators.

15. The distance-measuring unit as claimed in claim 14, the distance-measuring unit configured such that the solid angle segments which adjoin one another, but that are assigned to different angular ranges and thus different micromirror actuators, are scanned in a temporally offset manner.

16. The distance-measuring unit (1) as claimed in claim 1, wherein the distance-measuring unit is used for distance measurement based on a time-of-flight signal within a motor vehicle.
